(19) United States
(12) Patent Application Publication
(10) Pub. No.: US 2011/0111253 A1
(43) Pub. Date: May 12, 2011

(54) LEAD-FREE TIN PLATED MEMBER AND METHOD OF FORMING PLATING LAYER

(75) Inventors: Yasufumi Shibata, Aichi-ken (JP); Takashi Nomura, Aichi-ken (JP); Shigeru Konda, Aichi-ken (JP); Mitsuru Sakano, Aichi-ken (JP); Isamu Ichikawa, Aichi-ken (JP); Katsuhito Azuma, Toyama-ken (JP); Junichi Honda, Toyama-ken (JP); Satoshi Mizutani, Toyama-ken (JP)

(73) Assignee: TOYOTA JIDOSHA KABUSHIKI KAISHA, Toyota-shi, Aichi-ken (JP)

(21) Appl. No.: 13/002,226

(22) PCT Filed: Jun. 18, 2009
(86) PCT No.: PCT/IB2009/005967

§ 371 Date: Dec. 30, 2010

(30) Foreign Application Priority Data
Jul. 3, 2008 (JP) 2008-174996

(51) Int. Cl. C25D 3/30; C25D 5/50; B32B 15/01

(52) U.S. Cl. 428/647; 205/300

(57) ABSTRACT

In a plated member (3) that has a pure Sn plating layer (2) of a lead-free material on a surface of a base material 1, the orientation indices of a (101) plane and a (112) plane of the pure Sn plating layer are increased to values higher than the orientation indices of the other crystal orientation planes.

### BACKGROUND OF THE INVENTION

1. Field of the Invention

The present invention relates to a plated member and a method of forming a plating layer, and particularly to a plated member having a plating layer on a surface thereof as an external terminal in an electronic component such as a semiconductor device that an IC chip is mounted on a lead frame and to a method of forming a plating layer in such a plated member.

2. Description of the Related Art

For an external in an electronic component such as a semiconductor device, Copper, Copper alloy, brass, and Alloy 42 (metal alloy that contain 42% nickel by weight and at least iron) are used. However, since the surface of an external terminal may be oxidized if used as the base metal itself, it may result in conductivity defect due to soldering defect and the like. Therefore, a protection film (plating layer) is generally formed on the surface of the external terminal by plating to prevent oxidation.

In related arts, alloys containing lead are used when Sn alloys and the like are used as a material for the plating layer. However, it is recently desired that lead-free materials be used for the plating layer in view of reducing environmental load. Therefore, materials without lead, for example, pure tin (Sn) or Sn alloys such as Sn—Cu, Sn—Bi, and Sn—Ag alloys, are used for the material of the plating layer for the external terminal. However, if the surface of the external terminal of the electronic component is plated with the lead-free material, whiskers that are acicular single crystals of Sn, for example, are produced from the plating layer.

The whiskers may grow to several hundred micrometers. If the interval between the external terminals in the electronic part is as narrow as several hundred micrometers, the produced whiskers may cause a short circuit between the external terminals. Therefore, preventive measures against the production of whiskers are desired.

The mechanism how whiskers are produced and grow is not completely understood. However, it is considered that the internal stress accumulated in the plating layer is one of the factors. There are suggestions that the production of whiskers is prevented by removing the internal stress in the plating layer. For example, Japanese Patent Application Publication No. 2006-249460 (JP-A-2006-249460) discloses that a reflow process is applied by heating the plating layer that is formed of the Sn alloy without Pb at a temperature that is higher than the melting point of the alloy after the plating process, thereby releasing the internal stress, and thus the production of whiskers can be prevented.

It is also suggested that the crystal orientation planes of the plating layer and the orientation indices thereof are controlled to prevent the production of whiskers. For example, JP-A-2006-249460 discloses a technology that an Sn alloy phase is formed on the crystal grain boundary of the Sn plating layer to prevent the production of whiskers. In the technology, the orientation indices of a (220) plane and a (321) plane in the plating layer are increased to facilitate the formation of the Sn alloy phase.

Further, Japanese Patent Application Publication No. 2001-26898 (JP-A-2001-26898) discloses that when Pb-free electroplating is conducted with use of an Sn—Cu alloy plating bath, a brightener is mixed into plating solution and the electroplating is conducted at a current density of 0.01 to 100 A/dm².

It is difficult to say that the method of preventing whiskers that is suggested in the related arts are sufficiently effective. There still needs improvement. Particularly, sufficient analyses have not been made about the prevention of whisker production by controlling the crystal orientation planes of the plating layer and the orientation indices thereof.

### SUMMARY OF THE INVENTION

The present invention provides a plated member that has a plating layer of a lead-free material in which the plating layer has crystal orientation planes and the orientation indices thereof that can prevent the production of whiskers. The present invention provides a method of forming such a plating layer.

A first aspect of the present invention relates to a plated member that has a base material and a lead-free plating layer that consists of tin (Sn) and is formed on a surface of the base material. In the plated member, the orientation indices of a (101) plane and a (112) plane are larger than the orientation indices of the other crystal orientation planes among the crystal orientation planes on a surface of the plating layer.

In the plated member in accordance with the first aspect, the orientation index of the (101) plane may be not less than 1 and not more than 5, and the orientation index of the (112) plane may be not less than 5 and not more than 20.

The above configuration can prevent production of whiskers from the plating layer.

In the plated member in accordance with the first aspect, the base material may be Alloy 42 which contains 42% Ni by weight and at least iron.

A second aspect of the present invention relates to a method of forming a lead-free plating layer that consists of tin (Sn) on a surface of a base material. The method includes: applying electric current between plating solution in which metallic Sn and a brightener are mixed into an acidic solvent and the surface of the base material; and setting a current density in electric current application so that orientation indices of a (101) plane and a (112) plane are larger than the orientation indices of the other crystal orientation planes among the crystal orientation planes in a formed plating layer.

In accordance with the above configuration, the formed plating layer has the orientation indices of the (101) plane and the (112) plane larger than the orientation indices of the other crystal orientation planes, and can prevent the production of whiskers.

In the method in accordance with the second aspect, the brightener may be ketonic brightener or nonionic surface-active agent. In the method in accordance with the second aspect, the formed plating layer may be formed of pure Sn. The set current density may be not less than 1 A/dm² and not more than 3 A/dm².

The method in accordance with the second aspect may further include heating the formed plating layer to a specified temperature.

In the method in accordance with the second aspect, the predetermined temperature may be not more than the melting point of metallic Sn, may be 100 to 150° C., and may be 125° C.

The above configuration allows further increase in the orientation index of the (112) plane. Accordingly, the production of whiskers from the plating layer can be more certainly prevented.

In the method in accordance with the second aspect, the base material may be Alloy 42 which contains 42% Ni by weight and at least iron.

In the method in accordance with the second aspect, the metallic Sn component may be stannous sulfate, and the acidic solvent may be dilute sulfuric acid.

In the method in accordance with the second aspect, the orientation index of the (101) plane may be not less than 1 and not more than 5, and the orientation index of the (112) plane may be not less than 5 and not more than 20.

A plate member may have a plating layer that is formed on a surface of a base material by the method in accordance with the second aspect.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a diagram that illustrates a test plated member;

FIG. 2A is a photograph of a plating layer surface of a plated member in accordance with a first embodiment of the present invention, on which no whisker is produced;

FIG. 2B is a photograph of a plating layer surface of a plated member in accordance with a first comparative example, on which a whisker is produced;

FIG. 3 is a graph of an X-ray analysis of a plating layer surface in accordance with a second embodiment of the present invention (current density: 3.0 A/dm²);

FIG. 4 is a graph of an X-ray analysis of a plating layer surface in accordance with the second embodiment of the present invention (current density: 0.5 A/dm²);

FIG. 5 is a graph of an X-ray analysis of a plating layer surface in accordance with the second embodiment of the present invention (current density: 1.0 A/dm²);

FIG. 6 is a graph of an X-ray analysis of a plating layer surface in accordance with the second embodiment of the present invention (current density: 5.0 A/dm²);

FIG. 7 is a graph that indicates the relationship between orientation indices of a (101) plane and a (112) plane and current density; and

FIG. 8 is a graph for a comparison of the orientation index of the (112) plane between before and after heat treatment.

### DETAILED DESCRIPTION OF EMBODIMENTS

Descriptions will be made hereinafter with embodiments and comparative examples.

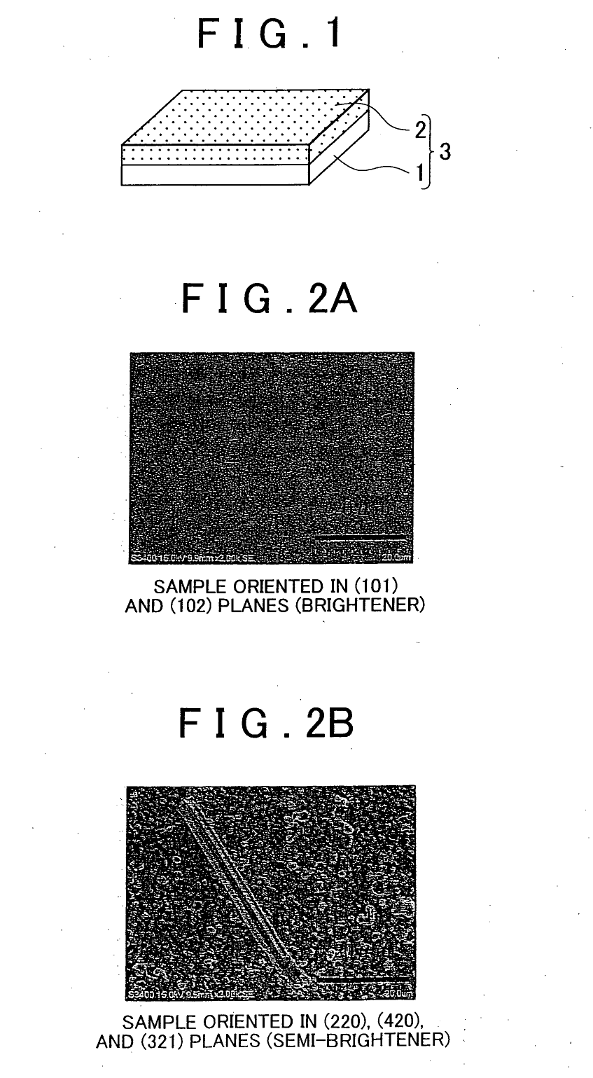

In a first embodiment, as shown in FIG. 1, electroplating was conducted on a base material 1 which was formed of Alloy 42 (an alloy that contains 42% Ni by weight and at least iron) in the conditions of the following table 1. A pure Sn plating layer 2 was formed on a surface of the base material 1, to form a test plated member 3.

TABLE 1

| | |
|---|---|
| Acidic solvent | Sulfuric acid |
| Metallic Sn component | Stannous sulfate: 15 g/L |
| Acid component | Purified dilute sulfuric acid: 183 cc/L |
| Particle conditioner | Brightener: 40 cc/L |
| Operating Temperature | 15° C. |
| Current density during plating | 3.0 A/dm² |

A thermal impact test that was performed in a cycle of 20 minutes between the high temperature of 60° C. and the low temperature of 0° C. was performed on the test plated member 3 for 1000 cycles, and whether or not whiskers were produced on the plating layer surface was observed by a scanning electron microscope. As the result is shown in FIG. 2A, the production of whiskers was not observed.

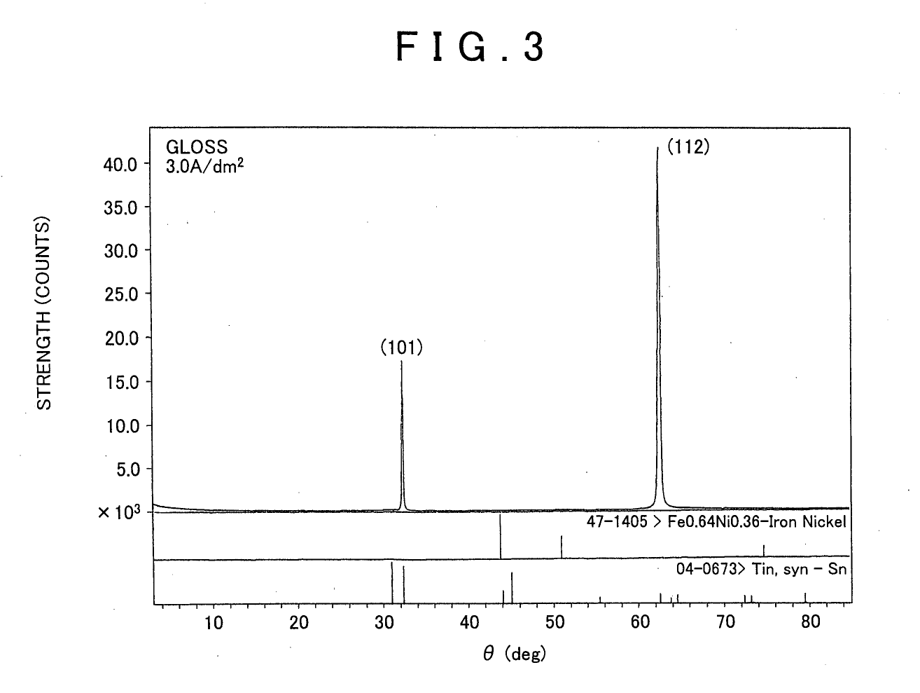

An X-ray analysis is performed on the test plated member 3 to analyze the crystal orientations on the plating layer surface. FIG. 3 shows the result. As shown in FIG. 3, peaks appear at a (101) plane and a (112) plane. The orientation index of the (101) plane is approximately 1. The index of the (112) plane is approximately 15. Few peaks were detected at the other crystal orientation planes.

In a first comparative example, electroplating was conducted in the conditions of the following table 2 on the same base material as the first embodiment. A pure tin (Sn) plating layer was formed on a surface of the base material to form a test plated member.

TABLE 2

| | |
|---|---|
| Acidic solvent | Alkanolsulfonic acid |
| Metallic Sn component | Tin methanesulfonate: 100 g/L |
| Acid component | Methanesulfonic acid: 113 cc/L |
| Particle conditioner | Semi-brightener: 30 cc/L |
| Operating Temperature | 25° C. |
| Current density during plating | 3.0 A/dm² |

The same thermal impact test as the first embodiment was performed on the test plated member. Whether or not whiskers were produced on the plating layer surface was observed by the scanning electron microscope. As FIG. 2b shows the result, whiskers in lengths of 50 μm or shorter were observed.

The crystal orientations on the pure Sn plating layer surface of the test plated member was analyzed by the X-ray analysis. Peaks were observed at a (220) plane, a (420) plane, and a (321) plane.

The first embodiment and the first comparative example reveal that when the orientation indices are increased on the (101) plane and the (112) plane of the plating layer surface, the production of whiskers can be prevented in the plated member on which the pure Sn plating layer is formed. Although the first comparative example was the pure Sn plating layer, the (220), (420), and (321) planes other than the (101) and the (112) planes had large orientation indices compared to the other planes. Thus, it can be assumed that whiskers were produced due to the larger orientation indices. Comparing the steps of the plating process between the first embodiment and the first comparative example, the steps were substantially the same except that a plating solution containing the brightener to add gloss on the plating layer surface was used in the first embodiment and that a plating solution containing the semi-brightener was used in the first comparative example. Therefore, it reveals that when the brightener is mixed into the plating solution in conducting the pure Sn plating process, the orientation indices of the (101) plane and the (112) plane can be increased on the pure Sn plating layer surface.

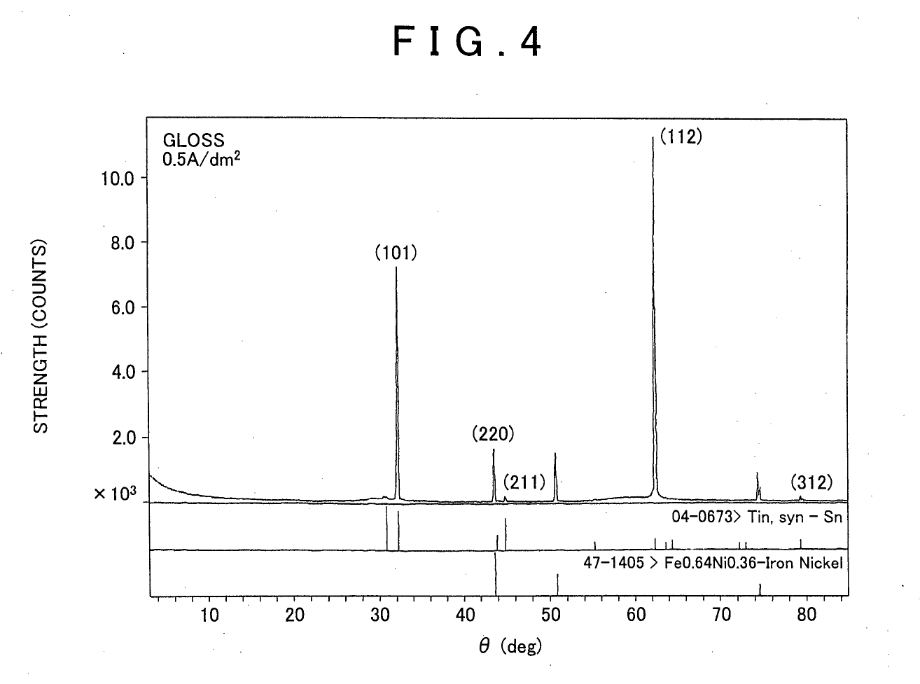

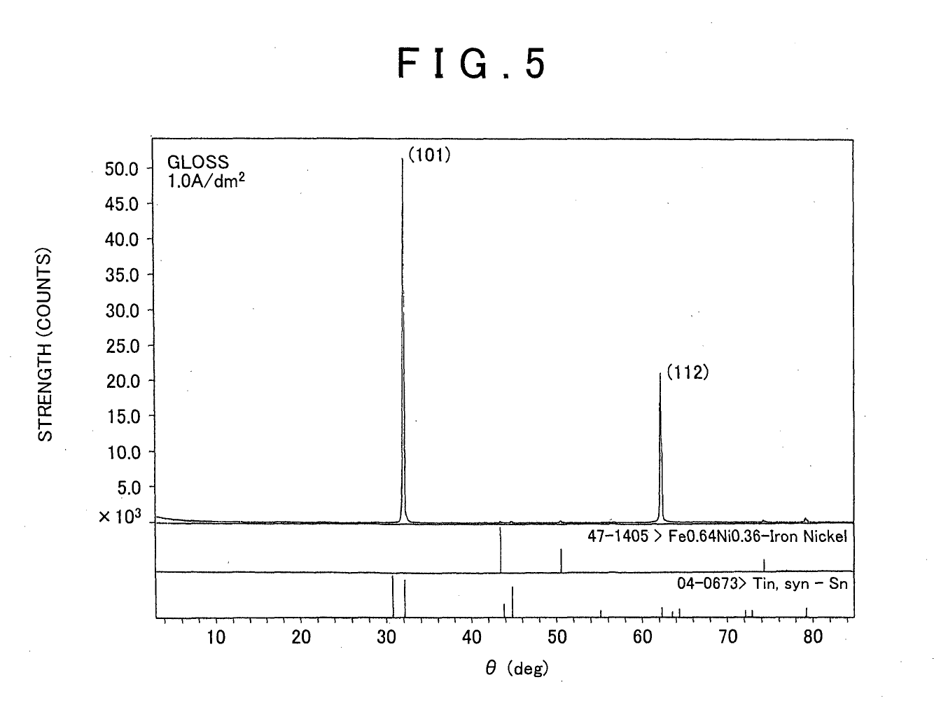

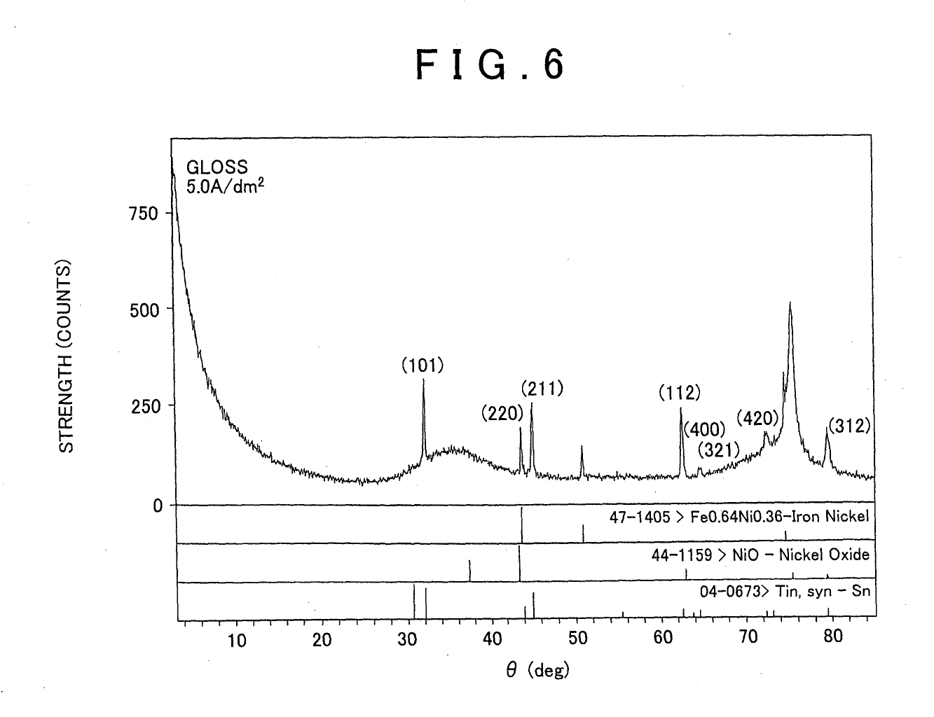

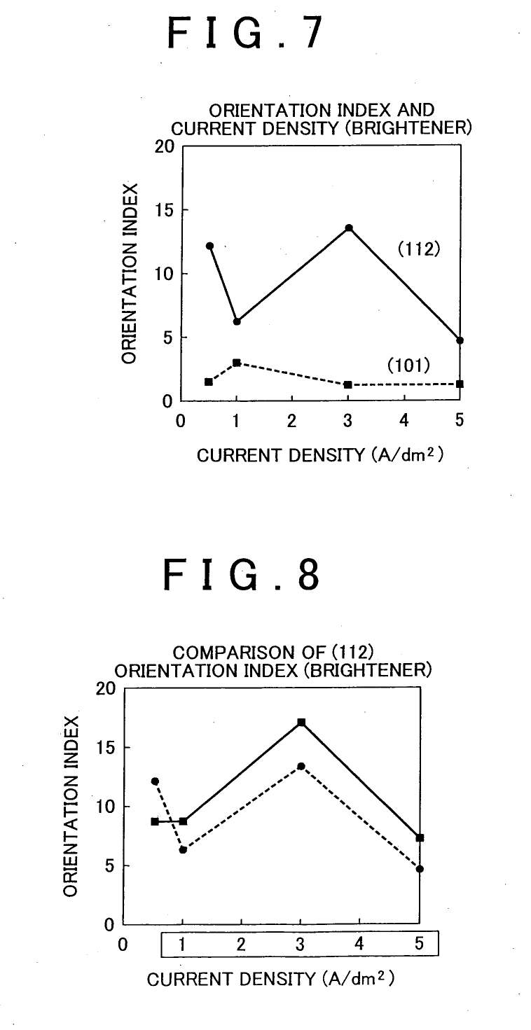

In a second embodiment, the same base material and the same plating solution as the first embodiment were used, and only the current density was adjusted to three levels of 0.5 A/dm², 1.0 A/dm², and 5.0 A/dm², to form test plated members. The crystal orientations on the plating layer surface of respective test plated members were analyzed by the X-ray analysis as performed in the first embodiment. The results are shown in FIG. 4 (0.5 A/dm²), FIG. 5 (1.0 A/dm²), and FIG. 6 (5.0 A/dm²). The orientation indices of the (101) plane and the (112) plane of each plated member are shown in FIG. 7. FIG. 7 also shows the orientation indices of the (101) plane and the (112) plane at the current density of 3.0 A/dm² in the first embodiment.

At the current density of 0.5 A/dm², the large orientation indices are indicated in FIG. 7 such that the orientation index of the (101) plane represented by a broken line is approximately 2 and the orientation index of the (112) plane represented by a solid line is approximately 12. However, as shown in FIG. 4, peaks appear at the orientation planes other than the (101) and the (112), planes such as the (220), a (211), and the (312) planes. Therefore, it is considered that the preventive effect against whisker production is slightly low compared to the first embodiment.

At the current density of 1.0 A/dm², the large orientation indices are indicated in FIG. 7 such that the orientation index of the (101) plane is approximately 4 and the orientation index of the (112) plane is approximately 6. Further, as shown in FIG. 5, few peaks appear at the orientation planes other than the (101) plane and the (112) plane. Therefore, it is considered that the preventive effect against whisker production as effective as the first embodiment can be obtained in this case.

At the current density of 5.0 A/dm², the large orientation indices are indicated in FIG. 7 such that the orientation index of the (101) plane is approximately 2 and the orientation index of the (112) plane is approximately 5. However, as shown in FIG. 6, peaks appear at the other orientation planes such as the (220), (211), (420), and (312) planes. It is considered that the preventive effect against whisker production is slightly low compared to the first embodiment.

From the results described above, it can be assumed that the plating steps are conducted at the current density of 1 to 3 A/dm² and thereby further higher preventive effect against whisker production can be obtained in the method of forming a plating layer in accordance with the present invention. If the current density in the plating steps is out of the range described above, slightly higher orientation indices are observed to some crystal orientation planes other than the (101) plane and the (112) plane although the orientation indices are lower than the (101) plane and the (112) plane. The preventive effect against whisker production lowers. It can be assumed that when the orientation index of the (101) plane is not less than 1 and not more than 5, and the orientation index of the (112) plane is not less than 5 and not more than 20, high preventive effect against whisker production can be obtained.

In a third embodiment, heat treatment at 125° C. for 40 hours was applied to the four test plated members that were obtained in the first and second embodiments after the formation of the plate layers. If the temperature of the heat treatment is less than 100° C., the heat treatment may require longer time. If the temperature of the heat treatment exceeds 150° C., the pure Sn plating layer melts and the crystal structure may change. The orientation indices of the (112) plane was obtained for the test plated members after the heat treatment. FIG. 8 shows the result with a solid line. FIG. 8 also shows the orientation indices of the (112) plane before the heat treatment with a broken line.

As shown in FIG. 8, because of the heat treatment, the orientation indices of the (112) plane are further higher on the test plated members that the plating process was conducted at the current densities of 1.0 A/dm², 3.0 A/dm², and 5.0 A/dm². From this result, it can be assumed that the heat treatment is further applied to the plating layer after the plating process and thereby yet higher preventive effect against whisker production can be obtained in the method of forming the plating layer in accordance with the present invention. No improvement in the orientation index of the (112) plane was observed on the test plated member that the plating process was conducted at the current density of 0.5 A/dm². This indicates that it is preferable that the plating process be conducted at the current density of 1 to 3 A/dm².

Exemplary brighteners in the embodiments of the present invention are ketonic brighteners, nonionic surface-active agents, and so forth.

In accordance with the present invention, in the plated member in which the pure Sn plate layer of lead-free materials is formed on the surface of the base material, the orientation indices of the (101) plane and the (112) plane at least on the surface of the pure Sn plating layer are increased higher than the orientation indices of the other crystal orientation planes, and thereby the production of whiskers on the pure Sn plating layer can be prevented. Therefore, the plated member in accordance with the present invention can be applied to, for example, terminals of a lead frame member of an IC chip in which the interval between the terminals is as narrow as several hundred micrometers.

While some embodiments of the invention have been illustrated above, it is to be understood that the invention is not limited to details of the illustrated embodiments, but may be embodied with various changes, modifications or improvements, which may occur to those skilled in the art, without departing from the spirit and scope of the invention.

1. A plating member that includes a base material and a lead-free plating layer that consists of Sn and is formed on a surface of the base material, characterized in that the orientation indices of a (101) plane and a (112) plane are larger than the orientation indices of the other crystal orientation planes among the crystal orientation planes on a surface of the plating layer.

2. The plated member according to claim 1, wherein the orientation index of the (101) plane is not less than 1 and not more than 5, and the orientation index of the (112) plane is not less than 5 and not more than 20.

3. The plated member according to claim 1 or 2, wherein the base material is Alloy 42 which contains 42% Ni by weight and at least iron.

4. A method of forming a lead-free plating layer that consists of Sn on a surface of a base material, characterized by comprising:
applying electric current between a plating solution in which metallic Sn component and a brightener are mixed into an acidic solvent and the surface of the base material; and
setting a current density in electric current application so that the orientation indices of a (101) plane and a (112) plane are larger than the orientation indices of the other crystal orientation planes among the crystal orientation planes in a formed plating layer.

5. The method according to claim 4, wherein the set current density is not less than 1 A/dm² and not more than 3 A/dm².

6. The method according to claim 4 or 5, further comprising heating the formed plating layer to a specified temperature.

7. The method according to claim 6, wherein the specified temperature is 100 to 150° C.

8. The method according to claim 7, wherein the heating is applied for 40 hours, and the specified temperature is 125° C.

9. The method according to any one of claims 4 to 8, wherein the base material is Alloy 42 which contains 42% Ni by weight and at least iron.

10. The method according to any one of claims 4 to 9, wherein the metallic Sn component is Stannous sulfate, and the acidic solvent is dilute sulfuric acid.

11. The method according to any one of claims 4 to 10, wherein the brightener is ketonic brightener or nonionic surface-active agent.

12. The method according to any one of claims 4 to 11, wherein the orientation index of the (101) plane is not less than 1 and not more than 5, and the orientation index of the (112) plane is not less than 5 and not more than 20.

13. A plated member characterized by comprising:
a base material; and
a plating layer that is formed on a surface of the base material by the method according to any one of claims 4 to 12.
